(19) United States
(12) Patent Application Publication
(10) Pub. No.: US 2023/0105469 A1
(43) Pub. Date: Apr. 6, 2023

(54) SCREEN CAPTURE PROTECTION USING TIME DECOMPOSITION

(71) Applicant: Citrix Systems, Inc., Fort Lauderdale, FL (US)

(72) Inventor: Jeffrey David Wisgo, Portland, OR (US)

(21) Appl. No.: 17/491,573

(22) Filed: Oct. 1, 2021

(51) Int. Cl. G06F 21/62; H04N 1/44; G06F 3/14

(52) U.S. Cl. CPC G06F 21/6245; H04N 1/448; G06F 3/14

(57) ABSTRACT

In one aspect, an example methodology implementing the disclosed techniques includes, by a computing device, splitting a content being displayed on a screen over time into a first plurality of frames and displaying on the screen the first plurality of frames in accordance with a frame rate. Each frame of the first plurality of frames can include a portion of the content such that a composite of the first plurality of frames shows the content. In some cases, the splitting of the content may include applying time decomposition to the content.

### BACKGROUND

With the recent advancements in technology, the use of computing devices has become ubiquitous. For example, as workforces are becoming increasingly mobile, many individuals are using computing devices to access network resources, such as web applications, to perform their jobs. Individuals are also becoming increasingly reliant on computing devices to perform personal tasks as more and more services and content are being made available online.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

Use of computing devices is increasingly becoming commonplace in today's fast-paced, technology-laden world. Often, the use of computing devices involves accessing, sharing, and/or displaying information. For example, a user can use a computing device to display content on a display screen of the computing device. The displayed content may include sensitive information which is intended only to be viewed by the user and not others near the user. However, when content is displayed on the display screen, there is a risk that a screenshot (e.g., an image) of the displayed content may be taken using an image capture device, such as a camera. Such copying or photocopying of the displayed content may result in the content being lost, leaked, or otherwise compromised. Embodiments of the present disclosure provide solutions to these and other technical problems described herein.

In accordance with one example embodiment provided to illustrate the broader concepts, systems, and techniques described herein, a method may include, by a computing device, responsive to a determination that a content being displayed on a screen includes a sensitive content, splitting the content over time into a first plurality of frames, each frame of the first plurality of frames including a portion of the content such that a composite of the first plurality of frames shows the content. The method may also include, by the computing device, displaying, on the screen, the first plurality of frames in sequence in accordance with a frame rate.

According to another illustrative embodiment provided to illustrate the broader concepts described herein, a system includes a memory and one or more processors in communication with the memory. The processor may be configured to split a content being displayed on a screen over time into a first plurality of frames, each frame of the first plurality of frames including a portion of the content such that a composite of the first plurality of frames shows the content, and display, on the screen, the first plurality of frames in sequence in accordance with a frame rate.

According to another illustrative embodiment provided to illustrate the broader concepts described herein, a method may include, by a computing device, splitting a content being displayed on a screen over time into a first plurality of frames, each frame of the first plurality of frames including a portion of the content such that a composite of the first plurality of frames shows the content. The method may also include, by the computing device, displaying on the screen the first plurality of frames in sequence in accordance with a frame rate.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4 is a block diagram of an illustrative computing device that can provide screen capture protection, in accordance with an embodiment of the present disclosure.

FIG. 5 is a diagram that illustrates time decomposition applied to a frame, in accordance with an embodiment of the present disclosure.

FIG. 6 is a diagram that illustrates time decomposed text content, in accordance with an embodiment of the present disclosure.

FIG. 7 is a diagram that illustrates time decomposed content displayed on two lenses, in accordance with an embodiment of the present disclosure.

FIG. 8 is a flow diagram of an illustrative process for generating and displaying time decomposed content, in accordance with an embodiment of the present disclosure.

FIG. 9 is a flow diagram of an illustrative process for generating and displaying time decomposed content on two lenses, in accordance with an embodiment of the present disclosure.

### DETAILED DESCRIPTION

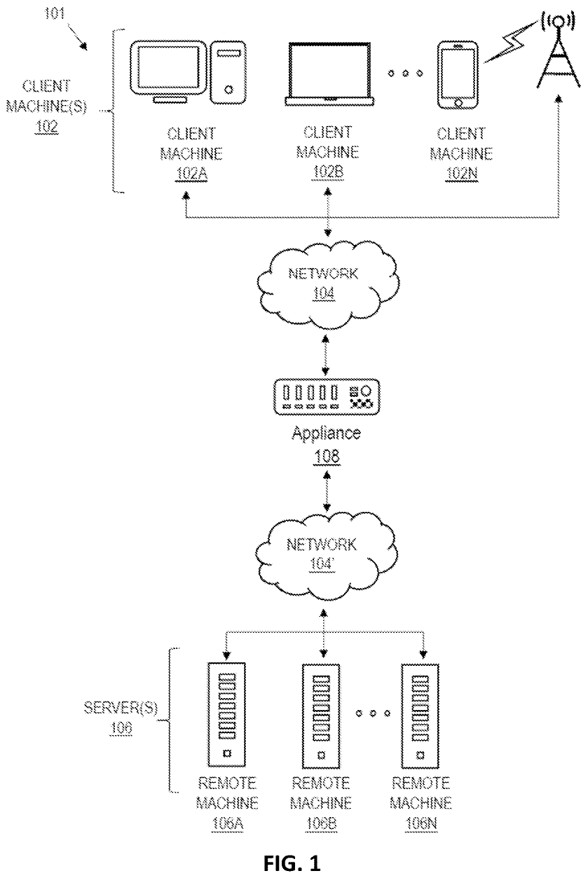

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

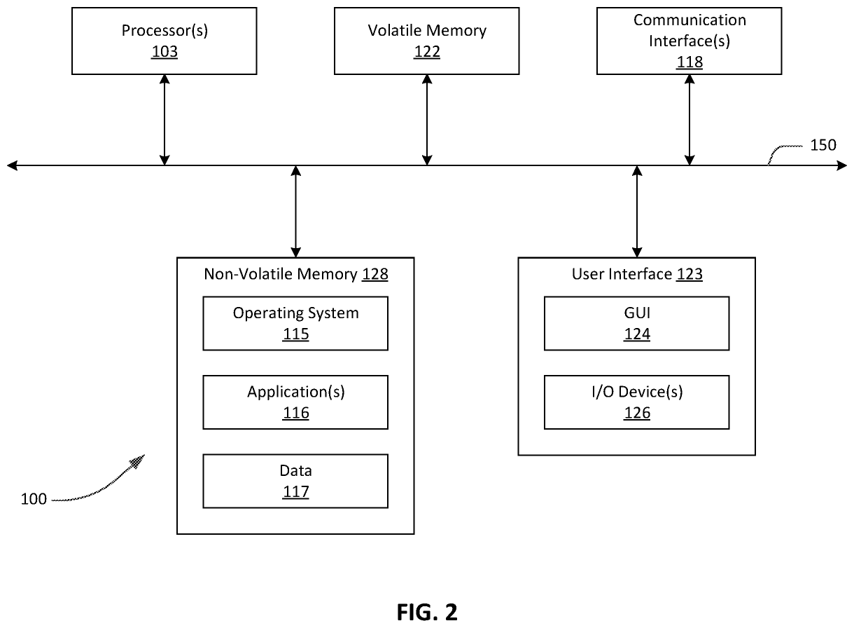

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (CPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

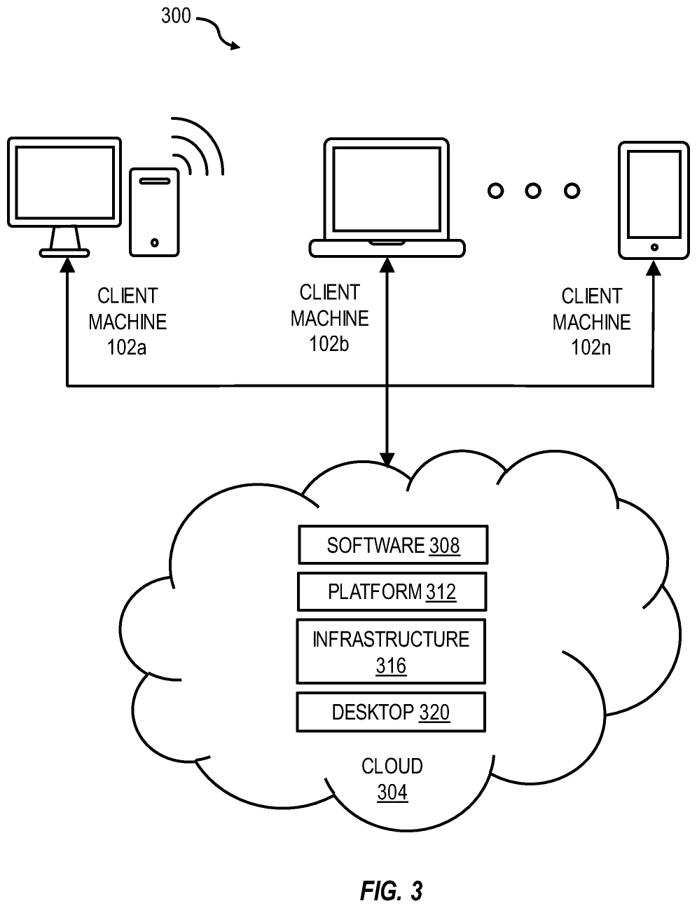

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

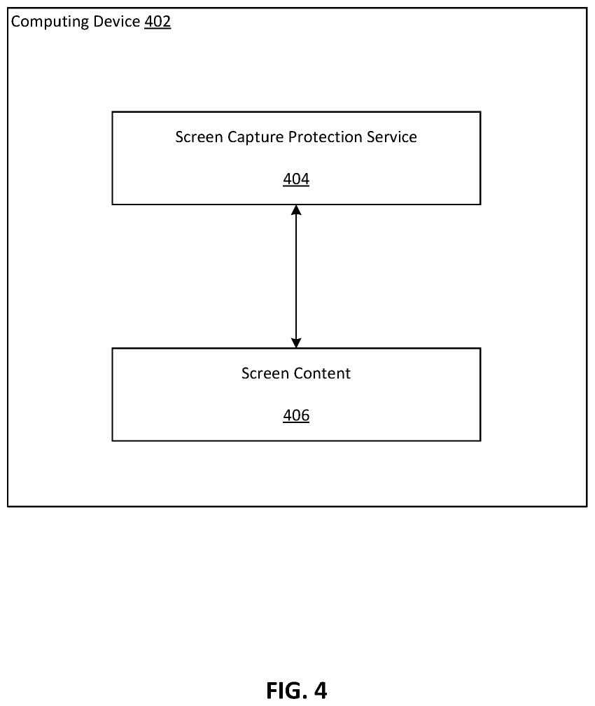

FIG. 4 shows an illustrative computing device 402 in which a screen capture protection service 404 can provide screen capture protection, in accordance with an embodiment of the present disclosure. In brief, screen capture protection service 404 can be understood as providing a screen capture protection feature on computing device 402. The screen capture protection feature can be enabled or disabled (which may be the default) on computing device 402, for example, by a user of computing device 402. When the screen capture protection feature is enabled, content displayed on a screen of computing device 402 is split up (i.e., decomposed) over time into several (e.g., two, three, four, or more) frames, such that only a portion of the content is rendered (included) in each frame and a composite of the several frames shows the content. The several frames containing portions of the content can then be displayed on the screen in sequence to show the content. A human viewing the screen can perceive the content that is being displayed. However, a screen capture (also known as a screen grab or a screen shot) will capture a single frame (e.g., an image of a single frame) which contains a rendering of only a portion of the content. As a result, the screen capture is of only a portion of the content and not the entire content.

Computing device 402 may include desktop computers, laptop computers, workstations, handheld computers, tablet computers, mobile devices, smartphones, and any other machine configured to install and run applications (or “apps”) such as user apps. In some embodiments, computing device 402 may be substantially similar to a client machine 102 described above in the context of FIGS. 1 and 3 and/or computing device 100 described above in the context of FIG. 2.

In more detail, when the screen capture protection service is enabled, screen capture protection service 404 can determine when content (e.g., screen content 406) is being displayed on a display screen of computing device 402. For example, in an implementation, screen capture protection service 404 can use an application programming interface (API) provided by an operating system (OS) running on computing device 402 to monitor the contents of a frame buffer. The frame buffer of computing device 402 contains or otherwise stores image data (e.g., a bitmap) representing all the pixels in a frame to be shown on the display screen. The image data in the frame buffer can be read to render a frame, which is an image of the content to show on the display screen. The rendered frame can then be output (displayed) on the display screen at a predetermined refresh rate to show the rendered frame (i.e., image of the content) on the display screen.

When content is being displayed by computing device 402, screen capture protection service 404 can read or otherwise obtain the content (e.g., image data) from the frame buffer. Screen capture protection service 404 can split up (i.e., decompose) the content over time into N frames such as two (2) frames, three (3) frames, four (4) frames, seven (7) frames, or any other suitable number of frames larger than one (1). When the content is split up in this manner, only a portion of the content is included in each of the N frames. In other words, the content is decomposed over time into N decomposed frames such that each of the N decomposed frames represents a period in the time decomposition of the content and shows only a portion of the content and not the entire content. Screen capture protection service 404 can then display the N frames on the display screen in sequence in accordance with a specified frame rate to show the content. For example, suppose screen capture protection service 404 splits up the content over time into four (4) frames, Frame 1, Frame 2, Frame 3, and Frame 4. In this example case, screen capture protection service 404 can first display Frame 1. After a specified time (which is generally in milliseconds) has elapsed, screen capture protection service 404 can display Frame 2. Screen capture protection service 404 can repeat this process to display Frame 3 and then Frame 4. After displaying Frame 4, screen capture protection service 404 can cycle back and display Frame 1 and repeat this process to display Frame 2, then Frame 3, and then Frame 4.

In some embodiments, screen capture protection service 404 can determine when the content that is being displayed on the display screen changes. For example, in an implementation, individual pixels of the display screen can be periodically compared against a back buffer, which may be a copy of the display screen, to determine whether any pixels have changed. In another implementation, a checksum can be calculated using the pixel information (e.g., pixel information of the display screen), and the checksum can be compared against a stored value of a checksum from the previous pixel information (e.g., pixel information of the previous display screen). A change in the checksum may indicate a change to one or more pixels. In another implementation, one or more of the operating system's APIs to a graphics layer of computing device 402 can be hooked to detect that a process has written some content to that layer (e.g., drawn a pixel, line, a character of text, etc.). Other detection techniques can be used. In any case, when a change to the content is detected, screen capture protection service 404 can split up the new content, which includes the changes, over time into several frames, and display the several frames on the display screen in sequence in accordance with the specified frame rate, as disclosed herein above.

In some embodiments, prior to splitting up the content that is being displayed over time into the N frames, screen capture protection service 404 can check to determine whether the content includes sensitive information. In an implementation, data loss prevention (DLP) and/or optical character recognition (OCR) techniques may can used to determine whether the content includes sensitive information. For example, DLP techniques may be used to scan the textual data in the content for certain keywords or phrases, and/or search the textual data using regular expressions, for patterns of characters to identify items of sensitive information contained in the content. Non-limiting examples of sensitive information include any data that could potentially be used to identify a particular individual (e.g., a full name, Social Security number, driver's license number, bank account number, passport number, and email address), financial information regarding an individual/organization, and information deemed confidential by the individual/organization (e.g., contracts, sales quotes, customer contact information, phone numbers, personal information about employees, and employee compensation information). Other pattern recognition techniques may be used to identify items of sensitive information. If it is determined that the content includes sensitive information, screen capture protection service 404 can split up the content, including the sensitive information, over time into N frames and then display the N frames on the display screen in sequence in accordance with a specified frame rate to show the content.

In some embodiments, the number of decomposed frames (e.g., N) may be based on the type of content that is being displayed. For example, if the content includes sensitive information, the content may be split up over time into a larger number of decomposed frames as compared to the number of decomposed frames utilized when the content does not include sensitive information. When content is split up into a larger number of decomposed frames, it is less likely for a single decomposed frame to include the sensitive information or a sufficient portion of the sensitive information for the sensitive information to be perceived from the single frame.

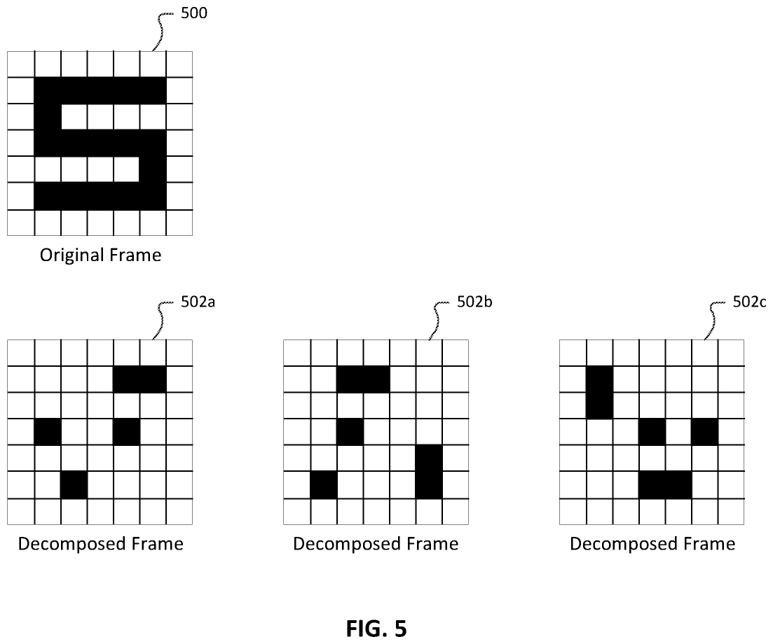

FIG. 5 is a diagram that illustrates time decomposition applied to a frame 500, in accordance with an embodiment of the present disclosure. More specifically, frame 500 may be an original frame of the content to be shown on a display screen. In the illustrated example of FIG. 5, the content may be text content in the form of the letter “S”, which can be split up over time into three (3) decomposed frames 502a, 502b, 502c. To split up the content, according to one embodiment, original frame 500 can first be partitioned into a multiple number of equal sized rectangular sections (tiles). Each tile may be of size 1 pixel, 2-pixel by 2-pixel, 4-pixel by 4-pixel, or any other suitable size. The letter “S” in original frame 500 can then be split up into decomposed frames 502a, 502b, 502c. For example, the time decomposition may specify that no more than two (2) tiles which show a portion of the letter “S” is connected in a decomposed frame (e.g., decomposed frame 502a, 502b, 502c). That is, in each of the decomposed frames 502a, 502b, 502c, at most two (2) tiles which show a portion of the letter “S” is connected. Decomposing the letter “S” in this way ensures that a single decomposed frame does not show the letter “S”. However, a composite of decomposed frames 502a, 502b, 502c shows the letter “S”. Decomposed frames 502a, 502b, 502c can then be displayed in succession (e.g., 502a, 502b, 502c, 502a, 502b, 502c, 502a, etc.) on the display screen to show the letter “S”.

While three (3) decomposed frames are illustrated in FIG. 5 for purposes of clarity, it will be appreciated that an original frame can be split up into a different number of decomposed frames. For example, the number of decomposed frames may be based on factors such as the type of content (e.g., text content, non-text content, a combination of text and non-text content) in the original frame, whether the content includes sensitive information, font size in the case of text content, or some combination thereof. Also, while a single text character is shown in the original frame illustrated in FIG. 5 for purposes of clarity, it will be appreciated in light of this disclosure that the illustrated time decomposition can similarly be applied to an original frame that includes a larger number of text characters as well as other types of content (e.g., non-text content).

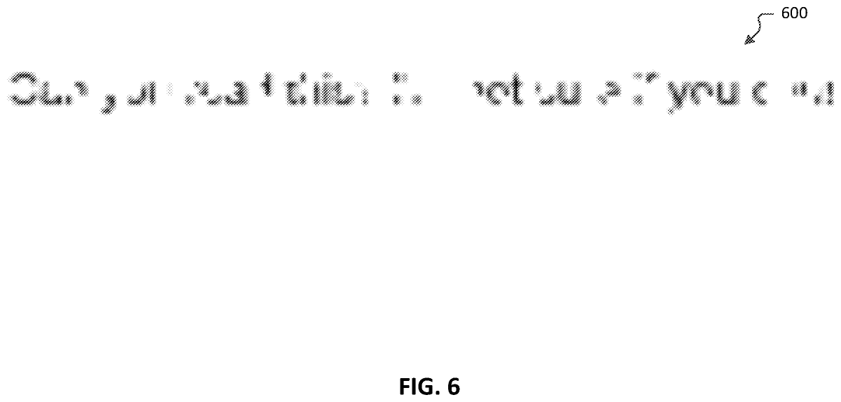

FIG. 6 is a diagram that illustrates time decomposed text content 600, in accordance with an embodiment of the present disclosure. Decomposed text content 600 may be a time decomposition of the text “Can you read this? I'm not sure if you can!” For example, in an original frame, the text “Can you read this? I'm not sure if you can!” may be black characters on a white background. In the example illustrated in FIG. 6, decomposed text content 600 can be generated by randomly selecting a subset of the black pixels (i.e., pixels whose color value is black) and converting the selected black pixels to white pixels. Decomposed text content 600 can then be rendered in a frame (e.g., one of N decomposed frames) and displayed on a display screen. In the time decomposition of FIG. 6, the number of decomposed frames, N, may be based on the sizes of the randomly selected subsets of black pixels (i.e., percentage of the black pixels randomly selected to be included in each subset). For example, larger numbers of decomposed frames may be needed if the sizes of the subsets of black pixels are smaller (i.e., smaller percentage of black pixels are randomly selected for each subset). As can be seen in FIG. 6, time decomposed content 600 rendered in a frame shows only a portion of the text “Can you read this? I'm not sure if you can!” More importantly, the portion of the content shown (e.g., time decomposed content 600) is insufficient to easily discern the text “Can you read this? I'm not sure if you can!”

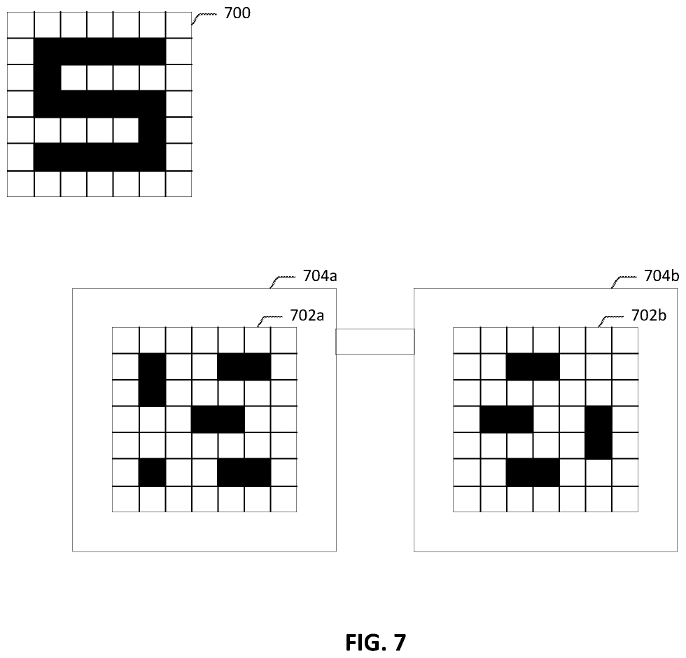

FIG. 7 is a diagram that illustrates time decomposed content displayed on two lenses, in accordance with an embodiment of the present disclosure. In the illustrated example of FIG. 7, content in an original frame 700 can be split up over time into two (2) decomposed frames 702a, 702b. As shown, the content (e.g., the letter “S”) in frame 700 can be split up into decomposed frames 702a, 702b such that each decomposed frame 702a, 702b shows only a portion of the letter “S”. For example, the content in frame 700 can be split up over time in a manner as described herein above in the context of FIG. 5 or FIG. 6. Decomposed frames 702a, 702b can then be displayed in respective lenses of eyeglasses such as the lenses of a virtual reality (VR) headset, VR goggles, VR glasses, or any other similar smart glasses. For example, as can be seen in FIG. 7, decomposed frame 702a can be displayed on a lens 704a and decomposed frame 702b can be displayed on lens 704b of a VR headset. As a result, a human wearing the VR headset is able to perceive the entire content (e.g., the letter “S”). However, an image of the content displayed on one of the lenses (e.g., an image of either decomposed frame 702a or decomposed frame 702b) will only show a portion of the content (e.g., a portion of the letter “S”).

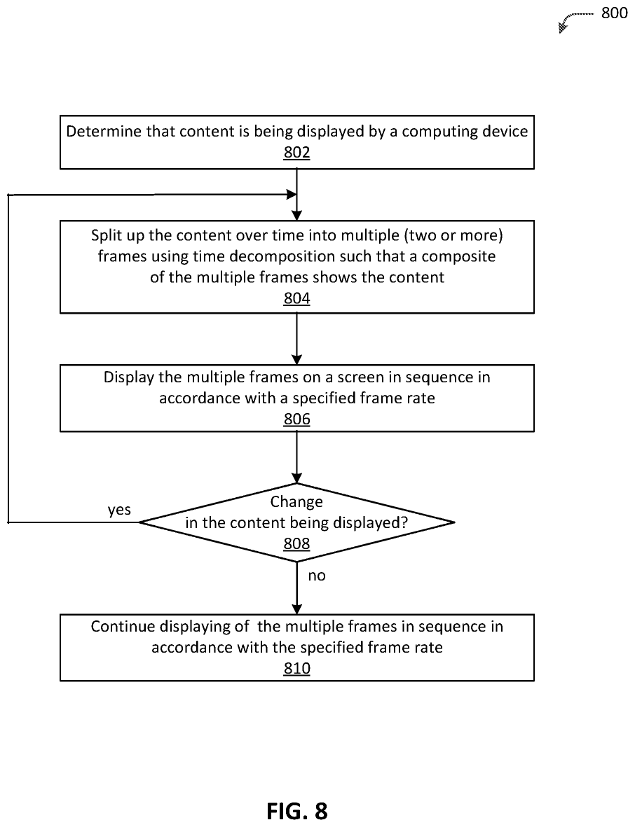

FIG. 8 is a flow diagram of an illustrative process 800 for generating and displaying time decomposed content, in accordance with an embodiment of the present disclosure. For example, process 800, and process 900 further described below, may be implemented or used within a computing environment or system such as those disclosed above at least with respect to FIG. 1, FIG. 2, FIG. 3, and/or FIG. 4. For example, in some embodiments, the operations, functions, or actions illustrated in example process 800, and example process 900 further described below, may be stored as computer-executable instructions in a computer-readable medium, such as volatile memory 122 and/or non-volatile memory 128 of computing device 100 of FIG. 2 (e.g., computer-readable medium of client machines 102 of FIG. 1, client machines 102a-102n of FIG. 3, and/or computing device 402 of FIG. 4). For example, the operations, functions, or actions described in the respective blocks of example process 800, and example process 900 further described below, may be implemented by operating system 115, applications 116, and/or data 117 of computing device 100.

With reference to illustrative process 800 of FIG. 8, process 800 may be implemented within a screen capture protection service (e.g., screen capture protection service 404 of FIG. 4) on a computing device. At 802, the screen capture protection service can determine that content is being displayed by the computing device. For example, a user may use the computing device to display content on a display screen of the computing device.

At 804, the screen capture protection service can split up the content over time into multiple (two or more) decomposed frames using time decomposition such that a composite of the multiple decomposed frames shows the content. Here, the individual decomposed frames show only a portion content and not the entire content. In other words, only a portion of the content is rendered in the different decomposed frames.

At 806, the screen capture protection service can display the decomposed frames on a display screen of the computing device in sequence in accordance with a specified frame rate. Once the last decomposed frame in the sequence is displayed, the screen capture protection service can cycle back to the first decomposed frame in the sequence and repeat the displaying of the decomposed frames. The displayed sequence of the decomposed frames shows the content.

At 808, the screen capture protection service can check to determine whether there is a change to the content that is being displayed. For example, an app running on the computing device may change the content and cause the display of the changed content on the display screen of the computing device.

If, at 808, the screen capture protection service determines that there is a change to the content, then, at 804, the screen capture protection service can again split up the content, which now includes the change(s) to the content, over time into multiple (two or more) decomposed frames using time decomposition such that a composite of the multiple frames shows the changed content. Then, at 806, the screen capture protection service can display the decomposed frames on the display screen of the computing device in sequence in accordance with the specified frame rate. The displayed sequence of the decomposed frames now shows the changed content.

Otherwise, if, at 808, the screen capture protection service determines that there is no change to the content, then, at 810, the screen capture protection service can continue displaying of the decomposed frames on the display screen of the computing device in sequence in accordance with the specified frame rate.

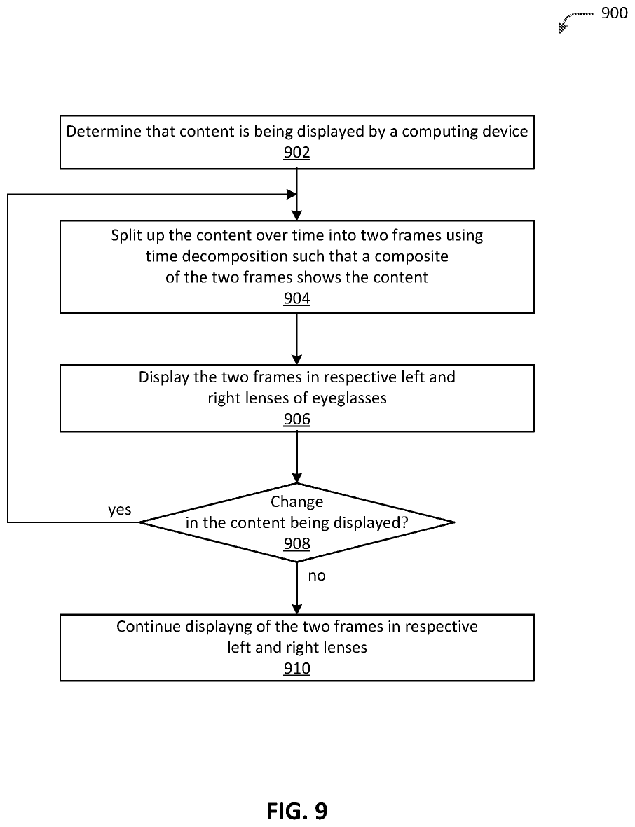

FIG. 9 is a flow diagram of an illustrative process 900 for generating and displaying time decomposed content on two lenses, in accordance with an embodiment of the present disclosure. For example, process 900 may be implemented within a screen capture protection service (e.g., screen capture protection service 404 of FIG. 4) on a computing device to display content on the lenses of eyeglasses such as VR glasses. At 902, the screen capture protection service can determine that content is being displayed by the computing device. For example, a user may use the computing device to display images (image content) on the lenses of VR glasses being worn by the user.

At 904, the screen capture protection service can split up the content over time into two (2) decomposed frames using time decomposition such that a composite of the two decomposed frames shows the content. Here, the individual decomposed frames show only a portion content and not the entire content. In other words, only a portion of the content is rendered in the different decomposed frames.

At 906, the screen capture protection service can display the decomposed frames on the lenses of the VR glasses. For example, the screen capture protection service can send or otherwise provide a video signal representing the decomposed frames to the VR glasses. The VR glasses can then display one decomposed frame in a left lens and the other decomposed frame in a right lens.

At 908, the screen capture protection service can check to determine whether there is a change to the content that is being displayed. For example, an app running on the computing device may change the content and cause the display of the changed content.

If, at 908, the screen capture protection service determines that there is a change to the content, then, at 904, the screen capture protection service can again split up the content, which now includes the change(s) to the content, over time into two (2) decomposed frames using time decomposition such that a composite of the two decomposed frames shows the changed content. Then, at 906, the screen capture protection service can display the decomposed frames on the lenses of the VR glasses.

Otherwise, if, at 908, the screen capture protection service determines that there is no change to the content, then, at 910, the screen capture protection service can continue displaying of the decomposed frames on the lenses of the VR glasses. For example, the VR glasses can continue to display one decomposed frame in the left lens and the other decomposed frame in the right lens.

### Further Example Embodiments

The following examples pertain to further embodiments, from which numerous permutations and configurations will be apparent.

Example 1 includes a method including, responsive to a determination, by a computing device, that a content being displayed on a screen includes a sensitive content: splitting the content over time into a first plurality of frames, each frame of the first plurality of frames including a portion of the content such that a composite of the first plurality of frames shows the content; and displaying, on the screen, the first plurality of frames in sequence in accordance with a frame rate.

Example 2 includes the subject matter of Example 1, wherein displaying the first plurality of frames is continual.

Example 3 includes the subject matter of any of Examples 1 and 2, wherein splitting the content includes splitting the content using time decomposition.

Example 4 includes the subject matter of any of Examples 1 through 3, further including, responsive to a change in the content: splitting the content over time into a second plurality of frames, each frame of the second plurality of frames including a portion of the content such that a composite of the second plurality of frames show the changed content; and displaying the second plurality of frames in sequence in accordance with the frame rate.

Example 5 includes the subject matter of any of Examples 1 through 4, wherein each frame of the first plurality of frames includes a distinct portion of the sensitive content.

Example 6 includes the subject matter of any of Examples 1 through 5, wherein the sensitive content includes text content.

Example 7 includes the subject matter of any of Examples 1 through 5, wherein the sensitive content includes non-text content.

Example 8 includes the subject matter of any of Examples 1 through 7, wherein splitting the content includes splitting a portion of the content, the portion of the content includes the sensitive content.

Example 9 includes the subject matter of any of Examples 1 through 8, wherein the first plurality of frames consists of a first frame and a second frame, and wherein the displaying of the first plurality of frames includes displaying the first frame on a first lens and displaying the second frame on a second lens.

Example 10 includes the subject matter of Example 9, wherein the first lens and the second lens are included in a virtual reality headset.

Example 11 includes a system including a memory and one or more processors in communication with the memory and configured to, responsive to a determination that a content being displayed on a screen includes a sensitive content: split the content over time into a first plurality of frames, each frame of the first plurality of frames including a portion of the content such that a composite of the first plurality of frames shows the content; and display, on the screen, the first plurality of frames in sequence in accordance with a frame rate.

Example 12 includes the subject matter of Example 11, wherein to display the first plurality of frames includes to display the first plurality of frames continually.

Example 13 includes the subject matter of any of Examples 11 and 12, wherein to split the content includes to split the content using time decomposition.

Example 14 includes the subject matter of any of Examples 11 through 13, wherein the one or more processors are further configured to, responsive to a change in the content: split the content over time into a second plurality of frames, each frame of the second plurality of frames including a portion of the content such that a composite of the second plurality of frames show the changed content; and display the second plurality of frames in sequence in accordance with the frame rate.

Example 15 includes the subject matter of any of Examples 11 through 14, wherein each frame of the first plurality of frames includes a distinct portion of the sensitive content.

Example 16 includes the subject matter of any of Examples 11 through 15, wherein the sensitive content includes text content.

Example 17 includes the subject matter of any of Examples 11 through 15, wherein the sensitive content includes non-text content.

Example 18 includes the subject matter of any of Examples 11 through 17, wherein to split the content includes to split a portion of the content, the portion of the content includes the sensitive content.

Example 19 includes the subject matter of any of Examples 11 through 18, wherein the first plurality of frames consists of a first frame and a second frame, and wherein to display the first plurality of frames includes to display the first frame on a first lens and to display the second frame on a second lens.

Example 20 includes the subject matter of Example 19, wherein the first lens and the second lens are included in a virtual reality headset.

Example 21 includes a computing device including a memory and one or more processors in communication with the memory and configured to: split a content being displayed on a screen over time into a first plurality of frames, each frame of the first plurality of frames including a portion of the content such that a composite of the first plurality of frames shows the content; and display, on the screen, the first plurality of frames in sequence in accordance with a frame rate.

Example 22 includes the subject matter of Example 21, wherein to split the content includes to split the content using time decomposition.

Example 23 includes the subject matter of any of Examples 21 and 22, wherein the one or more processors are further configured to, responsive to a change in the content: split the content over time into a second plurality of frames, each frame of the second plurality of frames including a portion of the content such that a composite of the second plurality of frames show the changed content; and display, on the screen, the second plurality of frames in sequence in accordance with the frame rate.

Example 24 includes the subject matter of any of Examples 21 through 23, wherein the content includes sensitive content.

Example 25 includes the subject matter of any of Examples 21 through 24, wherein the content includes text content.

Example 26 includes the subject matter of any of Examples 21 through 24, wherein the content includes non-text content.

Example 27 includes the subject matter of any of Examples 21 through 26, wherein the first plurality of frames consists of a first frame and a second frame, and wherein to display the first plurality of frames includes to display the first frame on a first lens and to display the second frame on a second lens.

Example 28 includes a method including: splitting, by a computing device, a content being displayed on a screen over time into a first plurality of frames, each frame of the first plurality of frames including a portion of the content such that a composite of the first plurality of frames shows the content; and displaying, by the computing device, on the screen the first plurality of frames in sequence in accordance with a frame rate.

Example 29 includes the subject matter of Example 28, wherein splitting the content includes splitting the content using time decomposition.

Example 30 includes the subject matter of any of Examples 28 and 29, further comprising, responsive to a change in the content: splitting, by the computing device, the content over time into a second plurality of frames, each frame of the second plurality of frames including a portion of the content such that a composite of the second plurality of frames show the changed content; and displaying on the screen, by the computing device, the second plurality of frames in sequence in accordance with the frame rate.

Example 31 includes the subject matter of any of Examples 28 through 30, wherein the content includes sensitive content.

Example 32 includes the subject matter of any of Examples 28 through 31, wherein the content includes text content.

Example 33 includes the subject matter of any of Examples 28 through 31, wherein the content includes non-text content.

Example 34 includes the subject matter of any of Examples 28 through 33, wherein the first plurality of frames consists of a first frame and a second frame, and wherein displaying the first plurality of frames includes displaying the first frame on a first lens and displaying the second frame on a second lens.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
responsive to a determination, by a computing device, that a content being displayed on a screen includes a sensitive content:
splitting the content over time into a first plurality of frames, each frame of the first plurality of frames including a portion of the content such that a composite of the first plurality of frames shows the content; and
displaying, on the screen, the first plurality of frames in sequence in accordance with a frame rate.

2. The method of claim 1, wherein displaying the first plurality of frames is continual.

3. The method of claim 1, wherein splitting the content includes splitting the content using time decomposition.

4. The method of claim 1, further comprising:
responsive to a change in the content:
splitting the content over time into a second plurality of frames, each frame of the second plurality of frames including a portion of the content such that a composite of the second plurality of frames show the changed content; and
displaying the second plurality of frames in sequence in accordance with the frame rate.

5. The method of claim 1, wherein each frame of the first plurality of frames includes a distinct portion of the sensitive content.

6. The method of claim 1, wherein the sensitive content includes text content.

7. The method of claim 1, wherein the sensitive content includes non-text content.

8. The method of claim 1, wherein splitting the content includes splitting a portion of the content, the portion of the content includes the sensitive content.

9. The method of claim 1, wherein the first plurality of frames consists of a first frame and a second frame, and wherein the displaying of the first plurality of frames includes displaying the first frame on a first lens and displaying the second frame on a second lens.

10. The method of claim 9, wherein the first lens and the second lens are included in a virtual reality headset.

11. A system comprising:
a memory; and
one or more processors in communication with the memory and configured to:
split a content being displayed on a screen over time into a first plurality of frames, each frame of the first plurality of frames including a portion of the content such that a composite of the first plurality of frames shows the content; and
display, on the screen, the first plurality of frames in sequence in accordance with a frame rate.

12. The system of claim 11, wherein to split the content includes to split the content using time decomposition.

13. The system of claim 11, wherein the one or more processors are further configured to, responsive to a change in the content:
split the content over time into a second plurality of frames, each frame of the second plurality of frames including a portion of the content such that a composite of the second plurality of frames show the changed content; and
display, on the screen, the second plurality of frames in sequence in accordance with the frame rate.

14. The system of claim 11, wherein the content includes sensitive content.

15. The system of claim 11, wherein the content includes text content.

16. The system of claim 11, wherein the content includes non-text content.

17. The system of claim 11, wherein the first plurality of frames consists of a first frame and a second frame, and wherein to display the first plurality of frames includes to display the first frame on a first lens and to display the second frame on a second lens.

18. A method comprising:
splitting, by a computing device, a content being displayed on a screen over time into a first plurality of frames, each frame of the first plurality of frames including a portion of the content such that a composite of the first plurality of frames shows the content; and
displaying, by the computing device, on the screen the first plurality of frames in sequence in accordance with a frame rate.

19. The method of claim 18, wherein splitting the content includes splitting the content using time decomposition.

20. The method of claim 18, wherein the first plurality of frames consists of a first frame and a second frame, and wherein the displaying of the first plurality of frames includes displaying the first frame on a first lens and displaying the second frame on a second lens.
